(19) United States
(12) Patent Application Publication
(10) Pub. No.: US 2009/0243714 A1
(43) Pub. Date: Oct. 1, 2009

(54) Power noise immunity circuit

(76) Inventors: Ming-Chun Chou, Banqiao-City (TW); Chun-Chung Huang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,763

(22) Filed: Mar. 24, 2009

(30) Foreign Application Priority Data
Mar. 25, 2008 (TW) 097110624

(51) Int. Cl. G05F 1/10; G05F 3/02

(52) U.S. Cl. 327/546; 327/545

(57) ABSTRACT

A power noise immunity circuit includes a unidirectional device and a switch both connected between a power input terminal and a power output terminal, and a noise detector to control the switch. The power input terminal is for being connected to an external voltage source, and the power output terminal is for being connected to the circuit of an IC. The switch is normally closed and is opened by the noise detector if the noise detector detects power noise at the power input terminal. The power noise immunity circuit thus prevents the IC from power breakdown and provides a stable voltage thereto.

### FIELD OF THE INVENTION

The present invention is related generally to a protective device for integrated circuits (ICs) and, more particularly, to a power noise immunity circuit for ICs.

### BACKGROUND OF THE INVENTION

The electronic devices of integrated circuits (ICs) are very sensitive to noise because they are very small and the powers they use are small. Therefore, high electromagnetic interference (EMI), especially the power noise, may cause an IC to be unintentionally shutdown or reset.

The present invention provides a power noise immunity circuit which, by actively and quickly detecting the power noise and immediately isolating the power noise, may protect ICs from harmful power noise.

### SUMMARY OF THE INVENTION

An object of the present invention is to provide a power noise immunity circuit for ICs.

According to the present invention, a power noise immunity circuit includes a unidirectional device connected between a power input terminal and a power output terminal, a switch is also connected between the power input terminal and the power output terminal, and a noise detector connected to the power input terminal and the switch. The noise detector monitors the power input terminal to control the switch. The switch is normally closed such that the input voltage is directly supplied to the power output terminal via the switch to be the output voltage thereon. However, if power noise is detected by the noise detector, the noise detector will immediately open the switch to cut off the current path therethrough.

Preferably, the switch, the unidirectional device and the noise detector are all implemented by MOS devices.

The noise detector may detect down-surging power noise, up-surging power noise, or both of them.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a circuit diagram of a first embodiment according to the present invention;

FIG. 2 is an embodiment implemented by CMOS devices for the circuit of FIG. 1;

FIG. 3 is a simulation diagram of the input voltage and the output voltage of the circuit of FIG. 2;

FIG. 4 is a circuit diagram of a second embodiment according to the present invention;

FIG. 5 is an embodiment implemented by CMOS devices for the circuit of FIG. 4;

FIG. 6 is a simulation diagram of the input voltage and the output voltage of the circuit of FIG. 5; and

FIG. 7 is a simulation diagram of the input voltage and the output voltage of the circuit which is a combination of the circuits of FIGS. 2 and 5 connected in series.

### DETAILED DESCRIPTION OF THE INVENTION

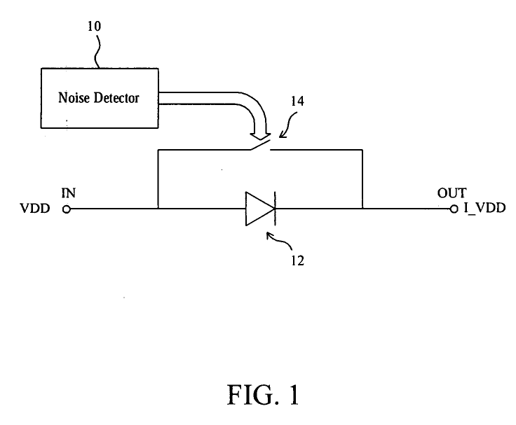

FIG. 1 is a circuit diagram of a first embodiment according to the present invention, in which a diode 12 is connected between a power input terminal VDD and a power output terminal I_VDD and so configured to establish a unidirectional current path from the power input terminal VDD to the power output terminal I_VDD, a switch 14 is also connected between the power input terminal VDD and the power output terminal I_VDD, and a noise detector 10 monitors the input voltage VDD at the power input terminal VDD to detect down-surging power noise in order to control the switch 14. The power input terminal VDD is for being connected to an external voltage source, and the power output terminal I_VDD is for being connected to the circuit of an IC to provide a protected voltage thereto. The switch 14 is normally closed such that the input voltage VDD on the power input terminal VDD will be directly supplied to the power output terminal I_VDD via the switch 14 to be the output voltage I_VDD. If the noise detector 10 does not detect any down-surging power noise at the power input terminal VDD, the switch 14 will keep closed; otherwise, the noise detector 10 will immediately open the switch 14 to cut off the current path therethrough, and the diode 12 becomes alive to connect the power input terminal VDD to the power output terminal I_VDD. The diode 12 may block power loss from the power output terminal I_VDD when down-surging power noise occurs, by which the diode 12 filters out the down-surging power noise at the power input terminal VDD, and the output voltage at the power output terminal I_VDD will be kept steady. As a result, the output voltage I_VDD will be not affected by the down-surging power noise at the power input terminal VDD, and a stable voltage can be supplied to the IC connected to the power output terminal I_VDD. The system protected by this power noise immunity circuit will be prevented from power breakdown.

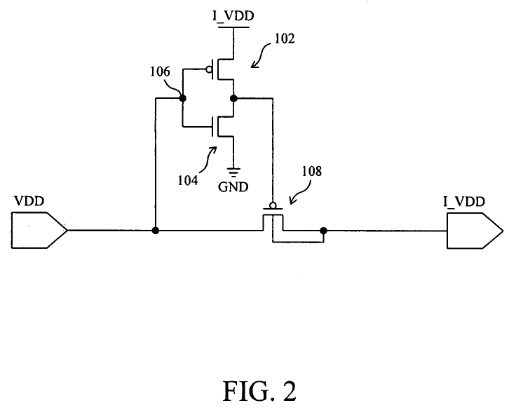

FIG. 2 is an embodiment implemented by CMOS devices for the power noise immunity circuit of FIG. 1. For the down-surging power noise detector 10 of FIG. 1, a PMOS transistor 102 and a NMOS transistor 104 are serially connected between the power output terminal I_VDD and a ground terminal GND, the gates of the PMOS transistor 102 and the NMOS transistor 104 are connected to the power input terminal VDD by a node 106, and the output of this noise detector 10 is connected to the gate of a PMOS transistor 108 which is connected between the power input terminal VDD and the power output terminal I_VDD. The PMOS transistor 108 itself serves as the switch 14 of FIG. 1, and its source is connected to its substrate such that the parasitic diode thereof serves as the diode 12 of FIG. 1. The voltage on the node 106 is normally VDD and could be regarded as a high-level voltage, and thus the PMOS transistor 102 is off and the NMOS transistor 104 is on. Hence, the gate voltage of the PMOS transistor 108 is zero and the PMOS transistor 108 is on. Therefore, the input voltage VDD is directly supplied to the power output terminal I_VDD via the PMOS transistor 108. If the input voltage VDD drops down to a low-level voltage because of down-surging power noise, causing the PMOS transistor 102 being on and the NMOS transistor 104 being off, the gate voltage of the PMOS transistor 108 become high (I VDD), and the PMOS transistor 108 is now regarded as a PN junction diode. In this case, the current can only flow from the power input terminal VDD to the power output terminal I_VDD, so as to lock the power source and keep the output voltage I_VDD steady.

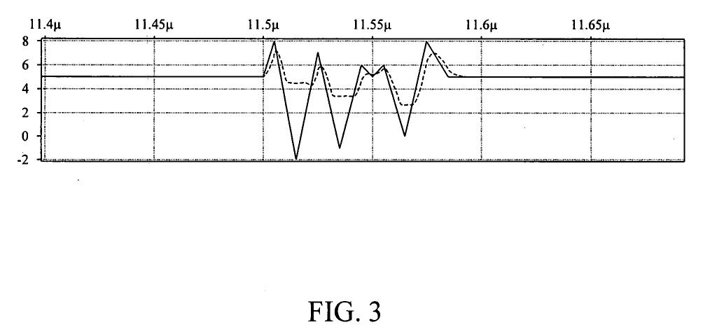

FIG. 3 is a waveform diagram obtained from an Hspice simulation to the circuit of FIG. 2, in which the real line shows the input voltage VDD and the dotted line shows the output voltage I_VDD under the protection of the power noise immunity circuit of FIG. 2. It is clearly shown that the down-surging power noise in the output voltage I_VDD is much smaller than that in the input voltage VDD.

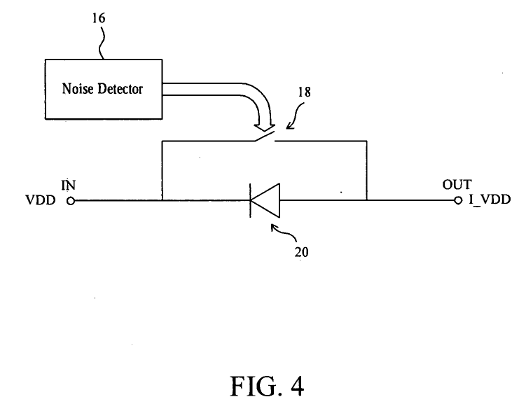

FIG. 4 is a circuit diagram of a second embodiment according to the present invention. The power input terminal VDD is also to be connected with an external voltage source, and a switch 18 is also connected between the power input terminal VDD and the power output terminal I_VDD. Between the power input terminal VDD and the power output terminal I_VDD, however, the diode 20 in this embodiment is connected in the opposite direction to that of FIG. 1. A noise detector 16 monitors the input voltage VDD to detect up-surging power noise in order to control the switch 18. The switch 18 is normally closed to connect the power input terminal VDD to the power output terminal I_VDD, such that the input voltage VDD is directly supplied to be the output voltage I_VDD via the switch 18, and is opened by the noise detector 10 if the noise detector 10 detects up-surging power noise at the power input terminal VDD, by which the up-surging power noise is blocked by the diode 20 and the output voltage I_VDD is kept steady.

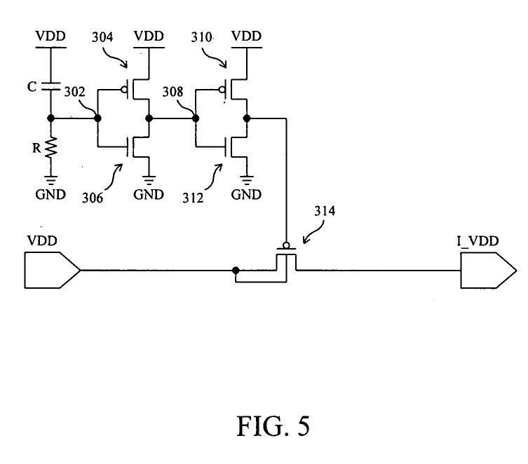

FIG. 5 is an embodiment implemented by CMOS devices for the circuit of FIG. 4. Again, in this embodiment, a PMOS transistor 314 is connected between the power input terminal VDD and the power output terminal I_VDD, to realize the switch 18 and the diode 20, which has its drain and substrate connected to each other. The noise detector in this embodiment includes a RC circuit and two pairs of PMOS and NMOS transistors, 304, 306 and 310, 312, connected between the power input terminal VDD and a ground terminal GND, to generate an output voltage applied to the gate of the PMOS transistor 314. The capacitor C and the resistor R are implemented by MOS devices, respectively. Normally, the RC circuit keeps the voltage on the node 302 at a low level, which turns on the PMOS transistor 304 and turns off the NMOS transistor 306, to generate a high-level voltage (VDD) on the node 308 to turn off the PMOS transistor 310 and turn on the NMOS transistor 312, thereby generating a low-level voltage applied to the gate of the PMOS transistor 314. Hence, the PMOS transistor 314 is normally on, and the input voltage VDD is directly supplied to the power output terminal I_VDD as the output voltage via the PMOS transistor 314. When up-surging power noise occurs, the voltage on the node 302 is pulled high through the capacitor coupling, and turns off the PMOS transistor 304 and turns on the NMOS transistor 306, such that the voltage on the node 308 is pulled low, to turn on the PMOS transistor 310 and turn off the NMOS transistor 312. As a result, the gate voltage of the PMOS transistor 314 becomes high and turns off the PMOS transistor 314. In this state, the PMOS transistor 314 could be regarded as a backward diode and therefore blocks the up-surging power noise at the power input terminal VDD to keep the output voltage I_VDD steady.

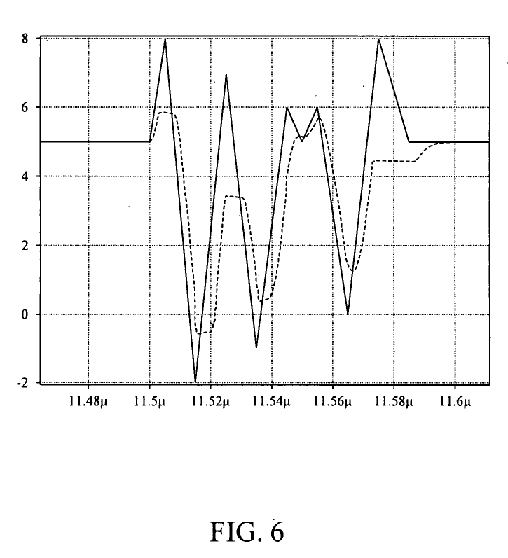

FIG. 6 is a waveform diagram obtained from an Hspice simulation to the circuit of FIG. 5, in which the real line shows the input voltage VDD and the dotted line shows the output voltage I_VDD under the protection of the power noise immunity circuit of FIG. 5. It is clearly shown that the up-surging power noise in the output voltage I_VDD is much smaller than that in the input voltage VDD.

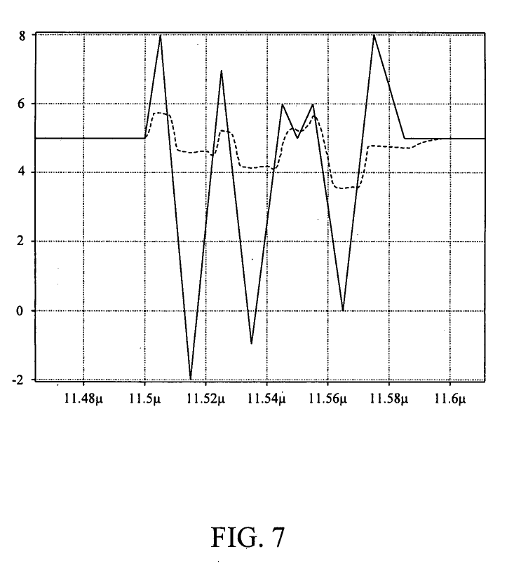

Preferably, a power noise immunity circuit for rejecting down-surging power noise, as that of FIG. 2 for example, and a power noise immunity circuit for rejecting up-surging power noise, as that of FIG. 5 for example, may be combined together, by connecting them in series, to form a more complete power noise immunity circuit. FIG. 7 is a waveform diagram obtained from an Hspice simulation to a circuit, in which the real line shows the input voltage VDD and the dotted line shows the output voltage I_VDD under the protection of this power noise immunity circuit. It is clearly shown that the output voltage I_VDD is more stable than the input voltage VDD, and is thus more suitable for supplying to ICs.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A power noise immunity circuit, comprising:
a power input terminal receiving an input voltage;
a power output terminal providing an output voltage;
a unidirectional device connected between the power input terminal and the power output terminal;
a switch connected between the power input terminal and the power output terminal; and
a noise detector connected to the power input terminal and the switch;
wherein the switch is normally closed and is opened by the noise detector if power noise is detected by the noise detector at the power input terminal.

2. The power noise immunity circuit of claim 1, wherein the noise detector detects down-surging power noise at the power input terminal to open the switch.

3. The power noise immunity circuit of claim 2, wherein the unidirectional device is conductive if a forward bias between the power input terminal and the power output terminal is present.

4. The power noise immunity circuit of claim 3, wherein the unidirectional device is a diode with a forward biased configuration between the power input terminal and the power output terminal.

5. The power noise immunity circuit of claim 3, wherein the unidirectional device is a PMOS transistor having a source connected to the substrate thereof.

6. The power noise immunity circuit of claim 1, wherein the noise detector detects up-surging power noise at the power input terminal to open the switch.

7. The power noise immunity circuit of claim 6, wherein the unidirectional device is conducted if a backward bias between the power input terminal and the power output terminal is present.

8. The power noise immunity circuit of claim 7, wherein the unidirectional device is a diode with a backward biased configuration between the power input terminal and the power output terminal.

9. The power noise immunity circuit of claim 7, wherein the unidirectional device is a PMOS transistor having a drain connected to the substrate thereof.

10. The power noise immunity circuit of claim 1, wherein the unidirectional device, the switch, and the noise detector are all implemented by CMOS devices.
